(19) United States
(12) Patent Application Publication
(10) Pub. No.: US 2026/0166967 A1
(43) Pub. Date: Jun. 18, 2026

(54) Air vent

(71) Applicant: KTX GmbH, Solingen (DE)

(72) Inventor: Uwe Schulz, Wuppertal (DE)

(73) Assignee: KTX GmbH, Solingen (DE)

(21) Appl. No.: 19/416,003

(22) Filed: Dec. 11, 2025

(30) Foreign Application Priority Data
Dec. 13, 2024 (DE) 102024137676.7

(51) Int. Cl. B60H 1/34; B60H 1/00

(52) U.S. Cl. CPC B60H 1/3421; B60H 1/0065; B60H 2001/3471

(57) ABSTRACT

An air vent for directing an air volume flow into an interior of a vehicle, includes a housing, a servomotor, a mechanical actuating element for adjusting a direction and/or a quantity of the air volume flow passing through the vent, and a control. The control is designed to control the servomotor. The mechanical actuating element is movably held on the housing. The servomotor is arranged for motorized adjustment of the actuating element. The control unit is attached to the housing, and the servomotor is attached to the housing. The control unit is designed to control one or more servomotors.

### CROSS-REFERENCE TO RELATED APPLICATION

This application claims the benefit of German Patent Application DE 102024137676.7, filed on Dec. 13, 2024, the content of which is incorporated by reference in its entirety.

### BACKGROUND

Vents in vehicles serve to direct air conditioned by the air conditioning system into a passenger compartment. Vehicles usually have a plurality of such vents, wherein the direction of the air flow and the amount of air emerging from a respective vent can be regulated by an operator.

In the simplest case, such a vent has a rotary wheel for manually opening and closing a closure flap in order to adjust the air flow. Furthermore, horizontal and vertical slats may be provided, which in turn can be adjusted manually and can be used to adjust the direction of the air flow entering the passenger compartment.

Vents that have servomotors for motorized adjustment of the actuating elements are also referred to as electric vents.

As an alternative or supplement to classic air conditioning with manual adjustment by the operator, modern motor vehicles increasingly offer automated and/or centrally controlled air conditioning systems. For example, different air conditioning settings for different areas of the passenger compartment and central control of all air conditioning functions via touch, gesture or voice-based user interfaces are possible.

In order to enable such semi-automatic or fully automatic climate control functions, it is common practice to use servomotor-controlled vents with controllable flaps or slats. For this purpose, one servomotor is used for each slat unit or flap to be controlled on the vent in question, which is provided as an assembly together with a respective servomotor control. Each servomotor therefore has its own servomotor control unit, which can be connected to the respective vehicle electrical power supply system via an interface.

Such a servomotor is usually enclosed together with its servomotor controller in a common servomotor housing and attached to the housing of the vent.

With regard to the design of vents, there is a requirement to make them as compact and cost-effective as possible. The installation space available for a particular vent in a vehicle is very limited, yet all the requirements for the servomotor control described above must still be met—at the lowest possible manufacturing cost.

Against this background, the present invention addresses the technical problem of providing an improved vent of the type mentioned at the outset, which is particularly compact, servomotor-controllable and cost-effective.

### SUMMARY

The present disclosure relates to a vent for directing an air flow into the interior of a vehicle, wherein the vent comprises: a housing, a servomotor, a mechanical actuating element for adjusting the direction and/or quantity of the air volume flow passing through the vent, and a control unit, wherein the control unit is designed to control the servomotor. The mechanical actuating element is movably mounted on the housing. The servomotor is designed to motorically adjust the actuating element. The control unit is mounted on the housing, and the servomotor is mounted on the housing.

The technical problem described above is solved by the features of the independent claim. Further embodiments are set out in the dependent claims and the following description.

A vent is provided for directing an air volume flow into the interior of a vehicle. The vent comprises: a housing, a servomotor, a mechanical actuating element for adjusting the direction and/or quantity of the air volume flow passing through the vent, and a control unit. The control unit is designed to control the servomotor. The mechanical actuating element is movably mounted on the housing. The servomotor is designed to motorically adjust the actuating element. The control unit is mounted on the housing, and the servomotor is mounted on the housing. The vent is distinguished in that the control unit is designed to control one or more servomotors.

In particular, it may be provided that the control unit is designed to control two or more servomotors.

The vent allows for modular expansion with additional servomotors, which can also be controlled using the same control unit. Compared to previously known vents, which provide a separate, motor-specific control unit for each servomotor, so that the number of control units corresponds to the number of servomotors used, installation space and costs can therefore be saved. This is because servomotors that have motor-specific integrated control units take up more space than servomotors that are provided and installed without their own control unit.

In particular, the control unit for the vent can be provided separately and independently of the servomotor and mounted on the vent housing.

The control unit can be attached to the housing separately from the servomotor and at a distance from the servomotor.

The control unit may, in particular, be a component that can be mounted and replaced separately and independently of the servomotor on the housing of the vent. This reduces the maintenance and repair costs for both the servomotor and the control unit.

According to one design of the vent, the servomotor does not protrude into a control housing of the control unit and is not attached to the control housing of the control unit. Servomotors are known in which the mechanical components protrude at least partially into a control housing of a control unit associated with the servomotor or are attached thereto. Such a solution is to be avoided in particular in the present case. Thus, the servomotor and the control unit should preferably not constitute a jointly mountable unit—in particular, they should not constitute a jointly mountable assembly.

In addition to the control of the vent, no further control should be provided. In particular, no control integrated as an assembly with the servomotor should be provided.

The control unit can be described as the central control unit of the vent, which can be set up to control several servomotors or all servomotors of the vent.

The control unit may have two or more connections for wired connection to two or more servomotors. The connections may be designed as part of a detachable plug connection, in particular as a plug or socket.

The control unit can be hard-wired to the associated servomotor so that, when fully assembled, a non-detachable, wired connection is formed between the control unit and the servomotor.

The control unit may have a control housing within which the electronic components of the control unit are enclosed, wherein the control housing is attached to the housing of the vent, and wherein the control housing is spaced apart from the servomotor.

The servomotor may comprise a servomotor housing within which mechanical components of the servomotor are enclosed, wherein the servomotor housing is attached to the housing of the vent, and wherein the servomotor housing is spaced apart from the control unit.

In particular, the servomotor housing and the control housing are spaced apart from each other and are not connected to each other.

A transmission can be assigned to the servomotor and coupled to it, wherein the transmission is coupled to the mechanical actuating element to be operated. An actuating movement of the servomotor can therefore be transmitted to the mechanical actuating element with the aid of the transmission. An actuating movement of the servomotor can be translated with the aid of the transmission. The transmission can have one or more of the following listed components: gearwheel, cam disc, crank, lever, belt, chain, tappet and the like.

The servomotor can be a rotary or linear motor. The servomotor can be a servomotor or a stepper motor. The servomotor can be a brushless or brushed DC motor. The servomotor can be operated using a passenger car's electrical power supply system.

The control unit may have an interface that is designed to be connected to the electrical power supply system of a motor vehicle.

The control unit may be designed to process signals from a touch-sensitive control element in the vehicle, such as a touch display or similar, for controlling the servomotor. The control unit may be designed to process signals from a voice or gesture control unit in the vehicle for controlling the servomotor.

The vent may have at least one cover or similar element which faces an operator in its finished state of assembly on the vehicle, wherein the cover has and/or forms a touch-sensitive control element for actuating the servomotor. The touch-sensitive control element may be a capacitive control element.

The mechanical actuating element may be manually operable, wherein the mechanical actuating element may be coupled to a mechanical actuating element, such as a rotary wheel, a lever, a handle or the like.

The vent may have two or more servomotors, in particular up to six servomotors.

The vent may have two or more mechanical actuating elements for adjusting the direction and/or quantity of the air volume flow passing through the vent, in particular up to six mechanical actuating elements.

A respective servomotor may be designed for motorized adjustment of at least one mechanical actuating element or for motorized adjustment of several mechanical actuating elements, wherein the control unit may be designed for central control of all servomotors.

The control unit may be attached to the housing separately from at least one of the servomotors and at a distance from this servomotor.

The control unit may be attached to the housing separately from at least two of the servomotors and at a distance from these two servomotors.

The control unit may be attached to the housing separately from each of the servomotors and at a distance from each of the servomotors.

It may be provided that at least one of the servomotors does not have its own control unit, wherein this servomotor is controlled exclusively by means of the control unit for the central control of all servomotors.

It may be provided that at least two of the servomotors do not have their own control unit, wherein these servomotors are controlled exclusively by means of the control unit for the central control of all servomotors.

It may be provided that none of the servomotors has its own control unit, wherein all servomotors are controlled exclusively by means of the control unit for central control of all servomotors.

It is understood that the statement that the servomotors are controlled exclusively by means of the control unit for the central control of all servomotors refers only to the vent assembly. When fully assembled in a vehicle, the control unit itself is connected, for example, to a control unit of the vehicle and can process signals and commands received from this control unit and control the servomotors on the basis of these signals and commands.

According to a design of the vent, it may be provided that at least one of the servomotors does not protrude into the control housing of the control unit and is not attached to the control housing of the control unit. As already mentioned, the respective servomotor in particular does not form an integrated assembly with a motor-specific control unit for the individual control of this one servomotor.

According to an embodiment of the vent, it may be provided that at least two of the servomotors do not protrude into the control housing of the control unit and are not attached to the control housing of the control unit.

According to one embodiment of the vent, it may be provided that none of the servomotors protrudes into the control housing of the control unit and none of the servomotors is attached to the control housing of a control unit.

At least one of the two or more mechanical actuating elements may be a guide element for changing the direction of the air volume flow in a first direction, such as a slat or the like.

At least one of the two or more mechanical actuating elements may be a guide element for changing the direction of the air volume flow in a first direction, such as a slat assembly or the like.

At least one of the two or more mechanical actuating elements may be a guide element for changing the direction of the air volume flow in a second direction different from the first direction, such as a slat or the like.

At least one of the two or more mechanical actuating elements may be a guide element for changing the direction of the air volume flow in a second direction different from the first direction, such as a slat assembly or the like.

At least one of the two or more mechanical actuating elements may be a closure element for adjusting and blocking the air volume flow, such as a closure flap or the like. The closure flap may be designed as a single piece or multiple pieces.

The closure flap can be adjustable between an open position, in which the entire air flow supplied to the vent penetrates the vent, and a closed position, in which no or substantially no air flow penetrates the vent.

In particular, one or more intermediate positions may be adjustable between the open position and the closed position for partially opening or closing the vent. The vent may be designed to allow stepwise or stepless adjustment of intermediate positions.

The mechanical actuating elements can be mounted on the housing in a self-locking manner so that there is no unwanted adjustment of the position of the mechanical actuating elements as a result of vibration during driving or under their own weight.

It may be provided that a respective servomotor has a maximum torque of 250 millinewton meters.

It may be provided that a respective servomotor has a weight of less than or equal to 50 grams.

It may be provided that a respective servomotor has a maximum speed of 15 revolutions per minute.

It may be provided that a respective servomotor has a length of less than or equal to 70 mm.

It may be provided that a respective servomotor has a width of less than or equal to 50 mm.

It may be provided that a respective servomotor has a height of less than or equal to 16 mm.

A respective servomotor can therefore be provided in a compact and cost-effective manner adapted to the present application.

### BRIEF DESCRIPTION OF THE DRAWINGS

The invention is explained in more detail below with reference to a drawing illustrating an embodiment.

FIG. 1A shows a first vent in a front view;

FIG. 1B shows the vent from FIG. 1A in a top view;

FIG. 1C shows the vent from FIG. 1A in a side view;

FIG. 2A shows a second vent in a front view;

FIG. 2B shows the vent from FIG. 2A in a top view;

FIG. 2C shows the vent from FIG. 2A in a side view;

FIG. 3A shows a third vent in a front view;

FIG. 3B shows the vent from FIG. 3A in a top view;

FIG. 3C shows the vent from FIG. 3A in a side view.

### DETAILED DESCRIPTION

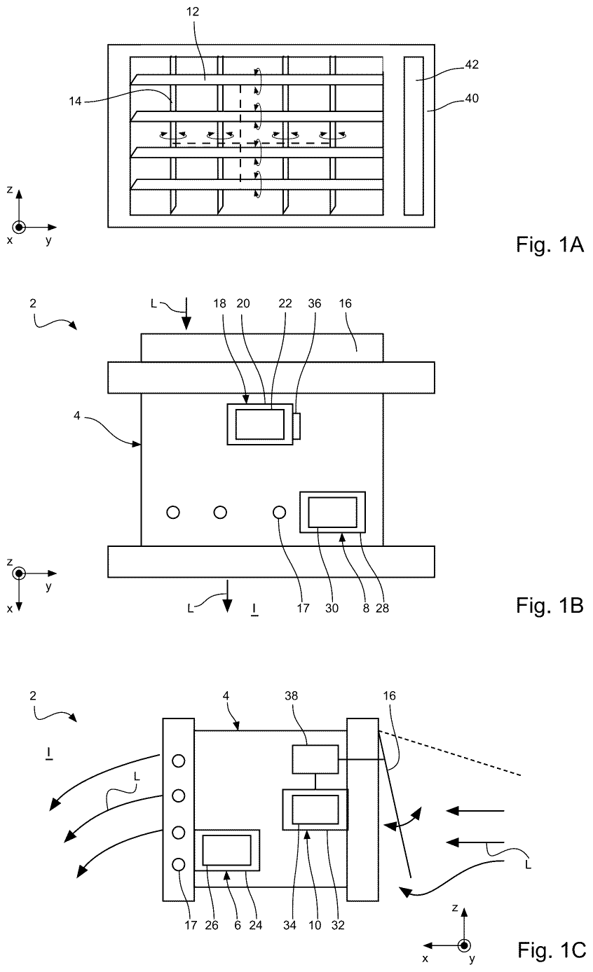

FIG. 1A shows a vent 2 for directing an air volume flow L into an interior space I of a vehicle. The vent 2 has a housing 4. The air volume flow L is generated, for example, by means of an air conditioning system of the vehicle (not shown).

In the present example, the vent 2 has three servomotors 6, 8, 10.

The vent 2 has mechanical actuating elements 12 in the form of horizontal slats 12, which are provided for adjusting the direction of the air volume flow L passing through the vent 2. In other words, the horizontal slats 12 serve to adjust the flow direction imposed on the air volume flow L when this air volume flow L leaves the vent 2 and is fed into the interior I of the vehicle.

Furthermore, the vent 2 has mechanical adjustment elements 14 in the form of vertical slats 14 which impose a direction on the air volume flow L as it flows into the interior I of the vehicle.

The horizontal slats 12 thus form guide elements 12 for changing the direction of the air volume flow in a first direction, while the vertical slats 14 form guide elements 14 for changing the direction of the air volume flow in a second direction different from the first direction.

The vent 2 has a further mechanical actuating element 16 in the form of a flap 16, which is designed to adjust the amount of air flow L passing through the vent 2.

The flap 16 can completely block the vent 2 so that no air from the vent 2 enters the interior I of the vehicle. The flap 16 can also be opened completely so that the entire air volume flow L supplied to the vent 2 passes through the vent 2. Furthermore, intermediate positions can be set so that a partial amount of the maximum possible air volume flow passes through the vent 2. This is shown schematically in FIG. 1C.

The mechanical actuating elements 12, 14, 16 are each movably attached to the housing 4. FIGS. 1B and 1C show, by way of example and schematically, bearing points 17 formed on the housing 4 for receiving the vertical and horizontal slats 12, 14.

The vent 2 has a control unit 18. The control unit 18 is designed to control the servomotors 6, 8, 10. The control unit 18 is attached to the housing 4. The servomotors 6, 8, 10 are attached to the housing 4.

The servomotor 6 is designed to motorize the adjustment of the horizontal slats 12. The horizontal slats 12 are mechanically coupled to each other so that an adjustment movement of the servomotor 6 is transmitted synchronously to all horizontal slats 12. The horizontal slats 12 form a slat assembly.

Adjusting the respective position of a respective horizontal slat 12 corresponds to changing the orientation of a respective slat 12 about a respective axis of rotation that is oriented parallel to the y-axis shown in FIG. 1A. The respective horizontal slats 12 are therefore rotated about their respective longitudinal axes by means of the associated servomotor 6 in order to set the desired orientation of the horizontal slats 12 and to direct the air volume flow with the aid of the slats 12.

The servomotor 8 is assigned to the vertical slats 14 and is designed for motorized adjustment of the vertical slats 14. The vertical slats 14 are mechanically coupled to each other so that an adjustment movement of the servomotor 8 is transmitted synchronously to all vertical slats 14. The vertical slats 14 form another slat assembly.

As previously described for the horizontal slats 12, the associated servomotor 8 also adjusts the rotational orientation of the vertical slats 14 around their respective longitudinal axes in order to impart a corresponding direction to the air volume flow L.

The servomotor 10 is assigned to the flap 16 and is designed to adjust a pivot position of the flap 16, wherein the amount of air flow L passing through the vent 2 is adjusted with the help of the pivot position of the flap 16.

The control unit 18 is arranged separately and at a distance from each of the servomotors 6, 8, 10.

None of the servomotors 6, 8, 10 protrudes into a control housing 20 of the control unit 18 or is attached to the control housing 20 of the control unit 18.

No further control unit is provided in addition to control unit 18. None of the servomotors 6, 8, 10 has a control unit integrated as a module, meaning that none of the servomotors 6, 8, 10 has an integrated, motor-specific or motor-individual control unit. All servomotors 6, 8, 10 are therefore controlled exclusively by means of the separate control unit 18 external to these servomotors 6, 8, 10, which forms a central control unit 18 for all servomotors 6, 8, 10.

Electronic components 22 of the control unit 18 are enclosed within the control housing 20 of the control unit. This control housing 20 is attached to the housing 4 of the vent 2 and is spaced apart from all servomotors 6, 8, 10.

The servomotor 6 has a servomotor housing 24, inside which mechanical components 26 of the servomotor 6 are enclosed.

The servomotor 8 has a servomotor housing 28, inside which mechanical components 30 of the servomotor 8 are enclosed.

The servomotor 10 has a servomotor housing 32, inside which mechanical components 34 of the servomotor 10 are enclosed.

Each of the servomotor housings 24, 28, 32 is attached to the housing 4 of the vent 2. Each of the servomotor housings 24, 28, 32 is spaced apart from the control housing 20 of the control unit 18.

Each of the servomotors 6, 8, 10 is a rotary motor in the present case.

The control unit 18 has an interface 36 that is designed for coupling with an electrical power supply system of a motor vehicle. By means of this interface 36, the control unit 18 can receive commands for controlling the servomotors 6, 8, 10.

A transmission 38 is assigned to the servomotor 10, wherein the transmission 38 is coupled to this servomotor 10, and wherein the transmission 38 is coupled to the mechanical actuating element 16 to be actuated, i.e., the flap 16.

The transmission 38 serves to translate and transmit the adjustment movement performed by the servomotor 10 to the flap 16. The transmission 38 may comprise, for example, gearwheels, levers, joints or the like in order to convert the adjustment movement of the servomotor 10 into the desired pivoting movement of the flap 16. According to alternative embodiments, such a transmission may also be assigned to each of the servomotors 6, 8.

The vent 2 has a cover 40 which faces an operator in its finished state of assembly on the vehicle, whereby the cover 40 has a touch-sensitive control element 42 for operating the servomotor 10. Accordingly, the air volume can be adjusted by means of touch control on the control element 42.

According to alternative exemplary embodiments, further touch-sensitive control elements for actuating the servomotors 6, 8 may be provided.

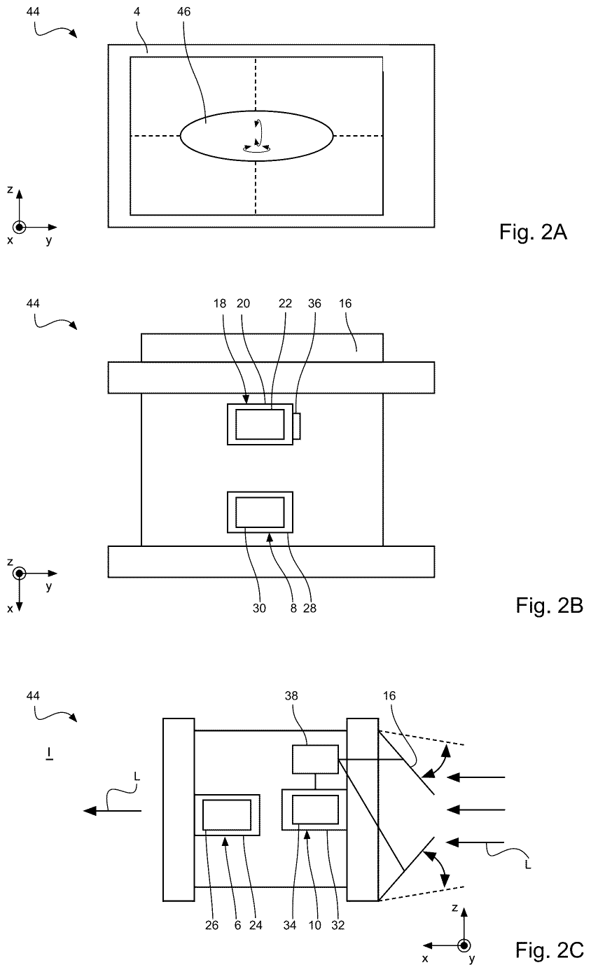

FIGS. 2A to 2C show a further embodiment of a vent 44, wherein, in order to avoid repetition, only the differences from the exemplary embodiment described above are discussed and the same reference signs are assigned to the same features.

Instead of horizontal and vertical slats, the vent 44 has a central mechanical adjustment element 46 that can be pivoted in the horizontal and vertical directions by means of the servomotors 6, 8 in order to adjust the direction of flow of the air volume flow L. The flap 16 is designed in two parts.

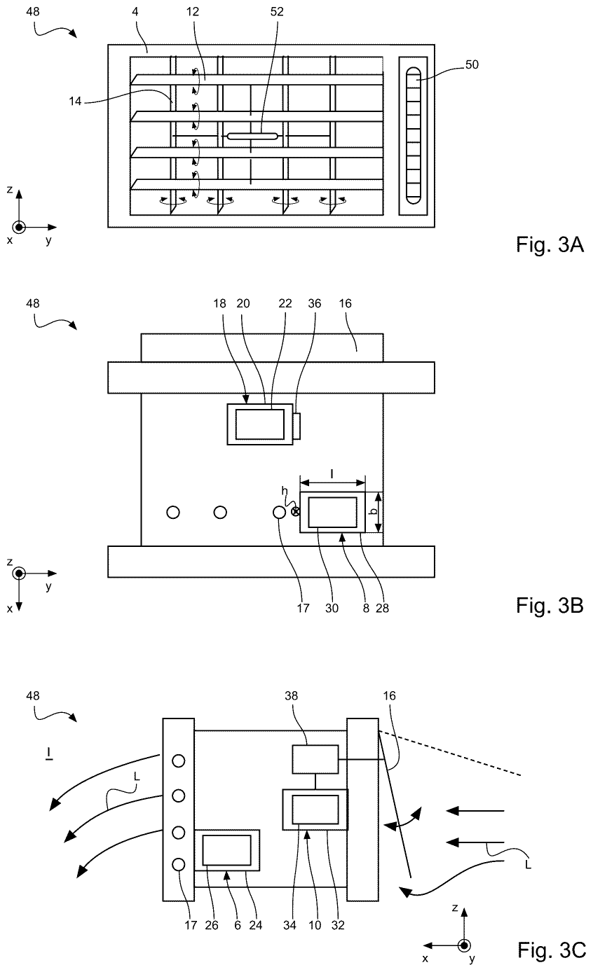

FIGS. 3A to 3C show a further embodiment of a vent 48, wherein, in order to avoid repetition, only the differences from the exemplary embodiment described above are discussed and the same reference signs are assigned to the same features.

The vent 48 according to FIGS. 3A to 3C differs substantially from the exemplary embodiments described above in that the mechanical actuating elements 12, 14, 16 can also be operated manually in addition to the servomotor actuation.

A rotary wheel 50 is provided for adjusting the pivot position of the flap 16.

Furthermore, a handle 52 is provided which is coupled to both the horizontal slats 12 and the vertical slats 14, so that an operator can adjust the position or orientation of the horizontal slats 12 and the vertical slats 14 by moving the handle 52 horizontally and/or vertically.

A respective servomotor 6, 8, 10 has a maximum torque of 250 millinewtonmeters. A respective servomotor 6, 8, 10 has a weight of less than 50 grams. A respective servomotor 6, 8, 10 has a maximum speed of 15 revolutions per minute.

Each servomotor 6, 8, 10 has a length l of less than or equal to 70 mm (see FIG. 3B). Each servomotor 6, 8, 10 has a width b of less than or equal to 50 mm (see FIG. 3B).

Each servomotor 6, 8, 10 has a height h of less than or equal to 16 mm. The height h is measured perpendicular to the length l and width b.

What is claimed is:

1. A vent for directing an air volume flow into an interior of a vehicle, comprising:
a housing;
a servomotor;
a mechanical actuating element configured to adjust a direction and/or a quantity of the air volume flow passing through the vent; and
a control unit,
wherein the control unit is configured to control the servomotor,
wherein the mechanical actuating element is movably mounted on the housing,
wherein the servomotor is arranged for motorized adjustment of the mechanical actuating element,
wherein the control unit is attached to the housing,
wherein the servomotor is attached to the housing, and
wherein the control unit is further configured to control at least one additional servomotor.

2. The vent according to claim 1,
wherein the control unit is attached to the housing separately from the servomotor and at a distance from the servomotor.

3. The vent according to claim 1,
wherein the servomotor does not protrude into a control housing of the control unit and is not attached to the control housing of the control unit, and/or
wherein the control unit is a sole control unit of the vent and the vent comprises no further control unit.

4. The vent according to claim 3,
wherein the control unit has a control unit housing within which electronic components of the control unit are enclosed, wherein the control unit housing is attached to the housing of the vent, and wherein the control unit housing is spaced apart from the servomotor, and/or
wherein the servomotor has a servomotor housing within which mechanical components of the servomotor are enclosed, wherein the servomotor housing is attached to the housing of the vent, and wherein the servomotor housing is spaced apart from the control unit.

5. The vent according to claim 1,
wherein a transmission is coupled to the servomotor and to the mechanical actuating element, and/or
wherein the servomotor is a rotary motor.

6. The vent according to claim 1,
wherein the control unit has an interface configured to be coupled to an electrical power supply system of a motor vehicle, and/or
wherein the control unit is configured to process signals from a touch-sensitive control element of the vehicle for controlling the servomotor and/or
wherein the vent has at least one cover which faces an operator in its finished state of assembly on the vehicle, wherein the cover has a touch-sensitive control element for actuating the servomotor and/or
wherein the mechanical actuating element can be operated manually, wherein the mechanical actuating element is coupled to a mechanical operating element selected from the group consisting of a rotary wheel, a lever, and a handle.

7. The vent according to claim 1,
wherein two or more servomotors are provided, and
wherein two or more mechanical actuating elements are provided for adjusting a direction and/or a quantity of the air volume flow passing through the vent,
wherein a respective servomotor is designed for the motorized adjustment of at least one mechanical actuating element or for the motorized adjustment of several mechanical actuating elements,
wherein the control unit is designed for a central control of all servomotors.

8. The vent according to claim 7,
wherein the control unit is separate from at least one of the servomotors and is mounted at a distance from this servomotor on the housing, or
wherein the control unit is attached to the housing separately from at least two of the two or more servomotors and at a distance from these two servomotors on the housing, or
wherein the control unit is attached to the housing separately from each of the two or more servomotors and at a distance from each of the two or more servomotors.

9. The vent according to claim 7,
wherein at least one of the servomotors does not have its own control unit, wherein the at least one of the servomotors is controlled exclusively by the control unit for the central control of all servomotors or
wherein at least two of the two or more servomotors do not have their own control unit, wherein these servomotors are controlled exclusively by the control unit for the central control of all servomotors, or
wherein none of the two or more servomotors has its own control unit, wherein all servomotors are controlled exclusively by the control unit for the central control of all servomotors.

10. The vent according to claim 7,
wherein at least one of the servomotors does not protrude into a control housing of the control unit and is not attached to the control housing of the control unit, or
at least two of the servomotors do not protrude into the control housing of the control unit and are not attached to the control housing of the control unit, or
none of the servomotors protrudes into the control housing of the control unit and none of the servomotors is attached to the control housing of the control unit.

11. The vent according to claim 7,
wherein at least one of the two or more mechanical actuating elements is a guide element for changing the direction of the air volume flow in a first direction,
at least one of the two or more mechanical actuating elements is a guide element for changing the direction of the air volume flow in a second direction different from the first direction, and
at least one of the two or more mechanical actuating elements is a closure element for adjusting and blocking the air volume flow.

12. The vent according to claim 1,
wherein a respective servomotor has a maximum torque of 250 millinewtonmeters and/or
wherein a respective servomotor has a weight of less than or equal to 50 grams and/or
wherein a respective servomotor has a maximum speed of 15 revolutions per minute.

13. The vent according to claim 1,
wherein a respective servomotor has a length of less than or equal to 70 mm and/or
wherein a respective servomotor has a width of less than or equal to 50 mm and/or
wherein a respective servomotor has a height of less than or equal to 16 mm.

14. A vent for directing an air volume flow into an interior of a vehicle, comprising:
a housing;
a first mechanical actuating element configured to adjust a direction and/or a quantity of the air volume flow passing through the vent, the first mechanical actuating element being movably mounted on the housing;
a first servomotor configured to adjust the first mechanical actuating element;
a second mechanical actuating element configured to adjust the direction and/or the quantity of the air volume flow passing through the vent, the second mechanical actuating element being movably mounted on the housing;
a second servomotor configured to adjust the second mechanical actuating element; and
a single control unit configured to control the first servomotor and the second servomotor, the single control unit being attached to the housing.
